(19) United States
(12) Patent Application Publication
(10) Pub. No.: US 2021/0031230 A1
(43) Pub. Date: Feb. 4, 2021

(54) KIT FOR HOUSEHOLD MAINTENANCE AND REPAIR AND METHODS OF USE THEREOF

(71) Applicant: The Willamette Valley Company, LLC, Eugene, OR (US)

(72) Inventor: Nathan E. Werst, Eugene, OR (US)

(21) Appl. No.: 16/936,933

(22) Filed: Jul. 23, 2020

Related U.S. Application Data
(60) Provisional application No. 62/880,842, filed on Jul. 31, 2019.

(51) Int. Cl. B05C 17/005; B05C 17/01; B65D 81/32

(52) U.S. Cl. CPC B05C 17/00559; B65D 81/325; B05C 17/014; B05C 17/00503

(57) ABSTRACT

A repair kit for use in repairing damaged portions of a surface or adhering objects and methods of using the repair kit are described herein. The repair kit comprises a housing having a first end and as second end, packaging in the form of a sealed container enclosing a resin component and a reactive component that react to form a polymeric composite material when mixed, a dispensing cap configured to engage with the first end of the housing and a pusher configured to engage with a second end of the housing. The sealed container includes a first removable divider engaged with the sealed container in a manner to form and create a first compartment and a second compartment. The polymeric composite material of the repair kit may be used as an adhesive, as a filler or sealant to repair damaged surfaces, pavements, walls, and wooden materials, and as a coating.

### CROSS-REFERENCE TO RELATED APPLICATIONS

This application claims the benefit of U.S. Provisional Patent Application No. 62/880,842, filed Jul. 31, 2019, the entire contents of which are hereby incorporated herein by reference.

### FIELD OF THE INVENTION

The present disclosure is generally related to a kit comprising components that can be mixed to form a polymeric composition for use in repairing damaged surfaces and methods for using such composition in households.

### BACKGROUND OF THE INVENTION

Polymeric composite materials can be used to repair and restore damaged surfaces. For example, polymeric composite materials may be used to patch cracks, holes, and the like in a variety of areas, such as walkways, driveways, and walls. Polymeric composite materials may also be used to adhere one object onto a second object. Polymeric composite materials generally include a mixture of a resin component, a reactive component, and a filler component. The components can be mixed together to form a polymeric composite that can be used in repairing damaged surfaces. Once the components are mixed together, the polymeric composite material remains pliable or “workable” for a relatively short time, e.g. 45 minutes, before the polymeric composite material cures and is no longer pliable. Thus, it is advantageous to use the polymeric composite material shortly after mixing of the components in order to take full advantage of the workable life of the composite material. As such, it is efficient and effective to mix the components at the site of use to maximize the usable life of the polymeric composite material.

For uses, such as household repairs, the components of polymeric composite materials may be provided in various types of packaging for consumers in order to allow for mixture and dispensing. One type of packaging that may be used is to provide the materials in a multi-component cartridge that may be attached to a cartridge dispenser. When the components of the polymeric composite are packaged in this manner, a consumer may be required to level the multi-component cartridge in order to make sure that an equal amount of each component is being released from the cartridge prior to use. Additionally, in order to allow for proper mixing of the two components and adequate dispensing of the mixed product, a static mix tube must be attached to an outlet of the cartridge. As such, this type of packaging can be cumbersome and can result in user exposure to undesirable chemicals during mixing. Furthermore, a user would be required to replace the static mix tube with a new static mix tube in between uses of the cartridge. Constant replacement of the static mix tubes could be expensive for consumer.

Another known method for packaging polymeric composite material for household uses includes providing a package with a frangible seal, which divides the components of the polymeric composite material. With such packaging, a user may break the frangible seal of the package and allow the components of the polymeric material to mix within the package. The package may have a dedicated outlet and a dispenser tube may be attached to the outlet for dispensing. However, dispensing the mixed polymeric composition product from packaging in this manner may awkward to the user and provide the less control during application.

### BRIEF SUMMARY

The present invention provides a kit for household maintenance and repair and methods of use thereof that addresses some of the disadvantages of conventional polymeric composite materials. In one aspect, a kit is provided. The kit includes a housing having a generally tubular configuration defining an interior space, a first end with a first opening and a second end with a second opening. The kit further includes a sealed container adapted to be positioned within the interior space of the housing. A divider is positioned along a transverse axis of the sealed container and forming a first compartment and a second compartment. The first compartment and the second compartment are isolated from one another by the divider. The kit also includes a pusher engageable the first end of the housing and a dispensing cap adapted to releaseably engage the second end of the housing, the dispensing cap having an opening. The first compartment of the sealed container includes a resin component having a resin density, and the second compartment includes a reactive component having a reactive component density. In some embodiments, the sealed container further comprises an aggregate component having a spherical shape, a diameter of about 0.1 mm to about 10 mm an aggregate density, wherein the density of the aggregate component is within 2 lbs./gallon of the density of at least one of the resin component or the reactive component wherein the density of the aggregate component is within 1 lbs./gallon of the density of the at least one of the resin component or the reactive component. In other embodiments, the housing is about 215 mm in length and about 50 mm in diameter. In yet still other embodiments, the sealed container includes a perforated detach line positioned near an end of the sealed container. The perforated detach line may be positioned along a transverse axis of the sealed container.

In another aspect, a method for securing an object is provided. The method includes removing a divider from a sealed container, the sealed container comprising a first compartment comprising a resin component and a second compartment comprising a reactive component, the divider isolating the first compartment from the second compartment. The method also includes mixing the resin component and the reactive component in the sealed container to form a composite material. The method further includes detaching at least a portion of an end of the sealed container to form a dispensing end. The method includes placing the sealed container into a housing, the housing having a generally tubular configuration, a first end with a first opening and a second end with a second opening. The method includes aligning the dispensing end of the sealed container with the second opening of the second end. Furthermore, the method includes positioning a pusher within an interior surface of the housing through the first end of the housing and releasably sealing a second end of the housing with a dispensing cap, the dispensing cap having an opening. The method includes placing the housing into a body of a dispensing apparatus. The method additionally includes dispensing the composite material upon the object by engaging the pusher and securing the object to the surface of the dwelling. In some embodiments, the dispensing cap includes a releasable dispensing nozzle. In other embodiments, the dispensing apparatus includes an actuator connected to a portion of the body, the actuator adapted to engage with the pusher.

In yet another aspect, a method for repairing a fissure is provided. The method includes removing a divider from a sealed container, the sealed container comprising a first compartment comprising a resin component and a second compartment comprising a reactive component, the divider isolating the first compartment from the second compartment. The method also includes mixing the resin component and the reactive component in the sealed container to form a composite material. The method further includes detaching at least a portion of an end of the sealed container to form a dispensing end. The method also includes placing the sealed container into a housing, the housing having a generally tubular configuration, a first end with a first opening and a second end with a second opening. The method includes aligning the dispensing end of the sealed container with the second opening of the second end. The method additionally includes positioning a pusher within an interior surface of the housing through the first end of the housing and releasably sealing a second end of the housing with a dispensing cap, the dispensing cap having an opening, and placing the housing into a body of a dispensing apparatus. The method further includes dispensing the composite material into the fissure by engaging the pusher.

In still yet another aspect, a method for applying a coating is provided. The method includes removing a divider from a sealed container, the sealed container comprising a first compartment comprising a resin component and a second compartment comprising a reactive component, the divider isolating the first compartment from the second compartment. The method also includes mixing the resin component and the reactive component in the sealed container to form a composite material. The method further includes detaching at least a portion of an end of the sealed container to form a dispensing end. The method includes placing the sealed container into a housing, the housing having a generally tubular configuration, a first end with a first opening and a second end with a second opening. The method also includes aligning the dispensing end of the sealed container with the second opening of the second end. The method includes positioning a pusher within an interior surface of the housing through the first end of the housing and releasably sealing a second end of the housing with a dispensing cap, the dispensing cap having an opening. The method includes placing the housing into a dispensing apparatus and coating an object or surface with the composite material.

### BRIEF DESCRIPTION OF THE DRAWINGS

Hereinafter, the invention will be explained in further detail, by way of example only, of the accompanying figures, in which:

FIG. 1 is a front plan view of home repair kit in accordance to an embodiment of the present invention.

FIG. 2 is a front plan view of an alternative embodiment of a sealed container of the home repair kit of FIG. 1.

FIG. 3 is bottom plan view of an embodiment of a pusher of the home repair kit of FIG. 1.

FIG. 4 is top plan view of an embodiment of a retention cap of the home repair kit of FIG. 1.

FIG. 5A is a front plan view of the home repair kit of FIG. 1 with the sealed container positioned within the housing and the housing is releaseably sealed.

FIG. 5B is a front plan view of the home repair kit of FIG. 1 with the sealed container positioned within the housing, the housing releaseably sealed, and a dispenser tube attached to one end of the housing.

FIG. 6 is a perspective view of the home repair kit of FIG. 1 positioned within a dispenser device.

### DETAILED DESCRIPTION

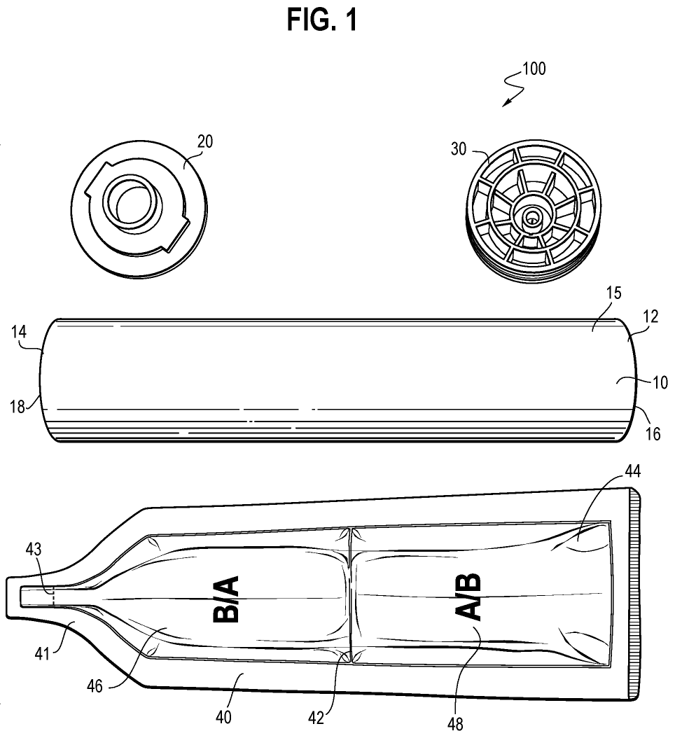

FIGS. 1-6 show embodiments of a repair kit for use in repairing damaged portions of a surface or adhering objects and methods of using the repair kit are described herein. The repair kit comprises a housing having a first end and as second end, packaging in the form of a sealed container enclosing a resin component and a reactive component that react to form a polymeric composite material when mixed, a dispensing cap configured to engage with the first end of the housing and a pusher configured to engage with and be releaseably attached to second end of the housing. The sealed container includes a first removable divider engaged with the sealed container in a manner to form and create a first compartment and a second compartment. The first compartment and the second compartment of the sealed container are separate and isolated from one another when the removable divider is in place. As such, the first compartment and second compartment are not in fluid communication with one another when the first removable divider is in place. The repair kit may also include a second removable divider that can form and create a third compartment, which is separate and isolated from the first and second compartments when the second removable divider is in place.

The repair kit described herein provides several advantages, particularly for household usage. For example, repairing damaged surfaces with the repair kit can be performed quickly and easily onsite; the polymeric composite material can be mixed by hand in a sealed container, which eliminates the possibility of exposure to the components, as well as potential waste of the components. In addition, the repair kit eliminates any waste associated with products prepared for single use as the repair kit provides a re-useable components that provide improved efficiency and repair kit more cost-effectiveness. The repair kit of the present invention improves the ability to dispense a polymer composite, which makes the polymer composite more useful for repairs and other household uses. For example, the repair kit may be used with standard dispensing apparatuses, such as a dispensing gun, in order to provide a convenient means for using the repair kit for household uses.

Regarding household usage, the polymeric composite material of the repair kit may be used at the interface of two substrates in order to provide permanent adhesion to a surface at or adjacent to a dwelling. For example, the repair kit may be used to secure a fixture to a wall or other surface. In another example, the repair kit may be used as a permanent adhesive to adhere a brick or other building material to a wall or surface. The polymeric composite of the repair kit may also be used in repair as a filler or sealant. Particularly, the polymer composite material of the repair kit may be placed into a crack, void, gap, or other opening in order to fix and seal, which may prevent further degradation of the surface within the home and return the surface to a desired and undamaged state. For example, include filling cracks in garage floors, repairing a split piece of wood, sealing a gap between two sections of wall, repairing a spalled section of concrete. Furthermore, the repair kit may be used in applications to coat a surface within a home. The polymer composite materials of the repair kit may be used to apply a coating having desirable properties onto a substrate. Examples include a durable clear coating for a table, a tough and abrasion resistant coating for the tow of a boot, or a healing/sealing surface for concrete.

The components used in the repair kit, may help to reduce, avoid or completely eliminate the “crashing out” effect of the components in the polymeric composite material. Density differences between the components can lead to a portion of the components settling to the bottom of the container shortly after mixing (i.e. “crashing out”), thus making the composite material unsuitable for use. Thus, exemplary embodiments of the repair kit comprise components having densities that are relatively similar to one another thereby reducing, minimizing or eliminating “crashing out” of a portion of the components.

FIG. 1 shows a repair kit 100 comprising a housing 10, dispensing cap 20, a pusher or plunger 30, and a sealed container 40. As shown, the housing 10 has a generally cylindrical shape and has an interior surface (not shown) and an exterior surface 15. The housing further includes a first end 12 and a second end 14. The first end 12 and the second end 14 of the housing 10 include a first opening 16 and a second opening 18. As will be discussed further in the application, the housing 10 is configured to receive the sealed container 40 within its body. Accordingly, the sealed container 40 may be introduced into the interior surface of the housing from either the first end 12 or the second end 14 of the housing 10.

The housing may include at least one attachment mechanism (not shown) positioned on the first 12 and second 14 ends of the housing 10 to facilitate releasable attachment of one or both of the dispensing cap 20 and the pusher 30. The attachment mechanism may be positioned on the interior surface of the housing or on the exterior surface of the housing. The attachment mechanism may comprise threads, clips, press fit, snap-fit arrangement, or other suitable known mechanism. In embodiments where the housing includes an attachment mechanism, the dispensing cap 20 and the pusher 30 may each have attachment mechanisms corresponding to the attachment mechanisms on the housing 10 in order to enable releasable attachment. The attachment mechanism on the first end 12 of the housing 10 may be the same or different than the attachment mechanism on the second end 14 of the housing 10.

The housing 10 may be comprises of rigid or semi-rigid materials known in the art such as plastic, metal, wood, cardboard, chipboard, stiff paper, foamed plastics, recycled materials, compostable materials, heavy foil, and/or combinations thereof; such as foamed or solid polystyrene, crystallized polystyrene, polyethylene terephthalate, polypropylene, polyethylene, or combinations thereof. In addition, the housing 10 may be can be constructed using conventional processes such as molding, casting, roll forming, and stamping. While the housing 10 in this embodiment comprise a generally cylindrical shape, the housing 10 in other embodiments may have a different configuration. By way of example, the housing 10 may comprise a generally rectangular, triangular, hexagonal, octagonal, square, or a combination thereof.

In addition, the housing 10 may have different dimensions and volumetric capacity. In some embodiments, the housing 10 may include a length less than 228 mm. In addition, the housing may have an inner diameter ranging from 43 mm to 49 mm and an outer diameter ranging from 49 mm to 51 mm. The inner diameter and the outer diameter of the housing may be selected such that the housing 10 has a thickness ranging between 12 mm to 16 mm. In a preferred embodiment, the housing 10 may have a length of about 215.9 mm, an outer diameter ranging from about 48.7 mm to 50.1 mm, and an inner diameter ranging from about 44.9 mm to 46.3.

As shown in FIG. 1, a sealed container 40 having a removable divider 42. The sealed container 40 generally may be made of any flexible material suitable for use as described herein. For example, the sealed container may be constructed from Mylar®. In one embodiment, the sealed container 40 is made of a material that does not react with the components used to make the polymeric composite material. In manufacturing the sealed container, an exterior surface 44 may be formed by two sheets of laminated material, sealed around the edges, or may be made from a tube cut into segments of appropriate length with the ends sealed.

When the removable divider 42 is in place, the resin component may be contained within the first compartment and the reactive component may be contained within the second compartment. When the first removable divider is removed, the resin component and the reactive component can be combined, mixed, and reacted to form the polymeric composite material. Advantageously, the repair kit utilizes a single sealed container enclosing the components that are mixed and reacted to form the polymeric composite material. The components that react are separated and isolated from one another prior to combining by one or more removable dividers. Because combining and mixing of the components takes places within the sealed container, exposure thereto during the mixing process is substantially eliminated during the mixing process thus reducing the risk of potential contamination of the components prior to mixing.

As can be seen in FIG. 1, the removable divider 42 is arranged transversely across the sealed container 40, and is configured to engage the sealed container 40 to form a first compartment 46 and a second compartment 48, which are separated and isolated from one another when the removable divider 42 is engaged with the sealed container 40. The removable divider crosses from one side of the sealed container 40 to the side directly opposite of it. The removable divider 42 may be a frangible seal. Other types of package sealing such as heat sealing, snaps, clips, inserts, or combinations thereof may be used as the removable divider. In a preferred embodiment, the removable divider 42 is a frangible seal. The frangible seal is designed such that by manually squeezing the sealed container 40, the amount of force required to rupture the frangible seal between the two compartments is exceeded. As such, the frangible seal opens and the contents of the two previously separated compartments are brought into fluid communication and can be mixed within the interior of the sealed container 40.

The divider 42 may or may not be completely physically removable from the sealed container 40. Rather, the term “removable” divider includes embodiments that are not completely physically separated from the sealed container but still provide separate and isolated compartments and can be manipulated so as to eliminate the separate compartmental nature of the sealed container.

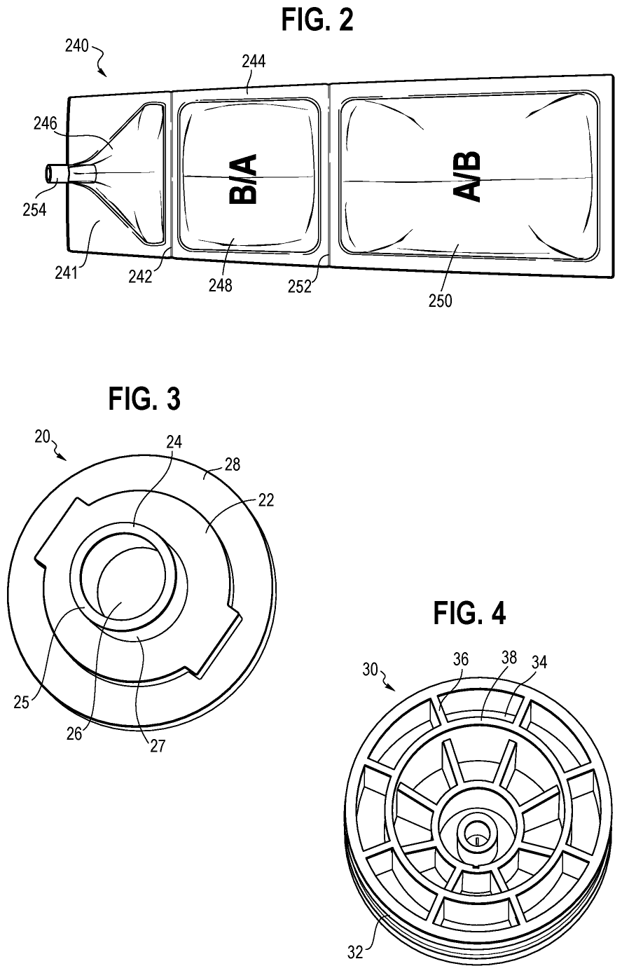

As indicated above, the removable divider 42 forms and creates two separate compartments within the sealed container 40. As shown in FIG. 1, the sealed container 40 includes a first compartment 46 and a second compartment 48. The size of the first compartment 46 and the second compartment 48 may depend upon the amount or volume of components being enclosed or housed within the compartment. In some embodiments, the compartments may contain a breathable aperture (not shown) for venting air from the compartment. The sealed container has a tapered, dispensing end 41 that allows for dispending of the contents of the sealed container 40. In some embodiments, the dispending end 41 may include a perforated detach line at one end of the sealed container 40 in order to allow for dispersion of the contents of the sealed container. In some embodiments, the perforated detach line 43 may be is positioned along a transverse axis of the sealed container. In other embodiments, the perforated detach line may be positioned at an angle less than 90 degrees with respect to a transverse axis of the sealed container. In yet other embodiments, the perforated detach line may be positioned at an angle greater than 90 degrees with respect to a transverse axis of the sealed container. In embodiments without a perforated detach line, the sealed container 40 may be cut in order to allow dispersing of the product. In other embodiments, as shown in FIG. 2, the dispensing end may include a tip to facilitate dispersion of the contents of the sealed container.

Referring back to FIG. 1, the removable divider 42 provides separation and isolation between the compartments during storage and transport of the repair kit 100. The removable divider 42 helps to avoid accidental combining of the components present in the compartments 46 and 48. When the removable divider 42 is removed, the first compartment 46 and the second compartment 48 are no longer present. Thus, the sealed container 10 has a single, interior compartment wherein the components can be combined and mixed.

After the removable divider 42 is disengaged, the components previously separated by the divider 42 may be combined within the sealed container 40. For example, the components may be mixed. Hand mixing of the components may be performed by shaking, tilting, turning, or moving the sealed container 40 for a time sufficient to form a significantly or completely homogenous polymeric composite material. The components may also be hand mixed by manipulating or squeezing the sealed container 40 for a time sufficient to form a significantly or completely homogenous polymeric composite material. Sufficient mixing can be performed by hand without the use of a mechanical apparatus that requires electrical power.

In one example, the time sufficient to form a significantly or completely homogenous mixture may be about 180 seconds, 120 seconds, 90 seconds, and/or 60 seconds. The amount of hand mixing required may depend upon one or more of the physical and/or chemical characteristics of the components. In some examples, the time sufficient to form a significantly or completely homogenous mixture of the components is over a range of about 15 seconds to about 300 seconds, preferably over a range of about 30 seconds to about 240 seconds, more preferably over a range of about 30 seconds to about 120 seconds. In some examples, the time sufficient to form a significantly or completely homogenous mixture of the components is for at least about 15 seconds, at least about 30 seconds, at least about 45 seconds, at least about 60 seconds, at least about 75 seconds, at least about 90 seconds, at least about 105 seconds, at least about 120 seconds, at least about 150 seconds, at least about 180 seconds, at least about 210 seconds, at least about 240 seconds, or at least about 270 seconds. In some examples, the time sufficient to form a significantly or completely homogenous mixture of the components is at most about 300 seconds, at most about 270 seconds, at most about 240 seconds, at most about 210 seconds, at most about 180 seconds, at most about 150 seconds, at most about 120 seconds, at most about 105 seconds, at most about 90 seconds, at most about 75 seconds, at most about 60 seconds, at most about 45 seconds, or at most about 30 seconds.

FIG. 2 provides an alternative embodiment of a sealed container 240 having a first removable divider 242, a second removable divider 252, and a dispensing outlet 254. In the sealed container 240 includes exterior surface 244. The first removable divider 242 and the second removable divider 250 are disposed transversely across the sealed container 140 from one side thereof to the side directly opposite. In the embodiment shown in FIG. 2, the first removable divider 242 and the second removable divider 252 are parallel to each other. The first removable divider 242 and the second removable divider 252 form and create three compartments within sealed container 240—a first compartment 246, a second compartment 248, and a third compartment 250. The first compartment 246 comprises the space between exterior surface 244 and removable divider 242. The third compartment 250 comprises the space between exterior surface 244 and removable divider 252. The second compartment 248 comprises the space between removable divider 246 and removable divider 252. Thus, the second compartment 248 is located between the first compartment 246 and the third compartment 250. The sealed container 240 also includes a dispensing end 241 comprising a dispensing tip 254.

In this embodiment, the second compartment 248 and the third compartment 250 may comprise the resin component and the reactive component, respectively. In other embodiments, the second compartment 248 and the third compartment 250 may comprise the reactive component and the resin component, respectively. The size of second compartment 248 and third compartment 250 may depend on one or more of the amount, the volume, and the ratio of components. The first removable divider 242 creates a separation between the contents of the second compartment 248 and the third compartment 250 to prevent premature dispensing of those contents. For example, after removing the second removable divider 252, the contents of the second compartment 248 and the third compartment 250 may be mixed. Following mixing, the first removable divider 246 may be removed and the mixed materials may be dispensed for use.

The sealed containers 40 and 240 of FIGS. 1 and 2 are generally configured to fit within the interior surface of the housing 10. In one embodiment, the sealed container has a width of less than 89 mm. In another embodiment, the sealed container has a width of at least 50.8 mm. In yet another embodiment, the sealed container has a width ranging from 50.8 mm to 76.2 mm. In a preferred embodiment, the sealed container has a width of 76.2 mm. The sealed container may have a length of at most 228.6 mm. In some embodiments, the sealed container has a length of about 216 mm. In a preferred embodiment, the sealed container has a length of about 213.4 mm and a width of 76.2 mm. The sealed container may have a volumetric capacity to hold approximately 275 mL of material.

The sealed container 40, 240 comprises components that, when mixed, react to form a polymeric composite material that can be used to repair damaged surfaces. The components that react to form the polymeric composite material are a resin component and reactive component. The resin component and the reactive component may be in the form of a liquid, solid, or a combination thereof. The repair kit 100 comprises components that, when mixed, react to form a polymeric composite material that can be used to repair damaged surfaces. The components that react to form the polymeric composite material are a resin component and reactive component. The resin component and the reactive component may be in the form of a liquid, solid, or a combination thereof. The repair kit can also include a catalyst to accelerate the reaction between the resin and the reactive component. The catalyst may also be in the form of liquid or solid. The filler will typically be in the form of a solid.

Different types of resin components may be used to form the polymeric composite material. For example, an epoxy resin or a polyol resin may be used. If a polyol resin is used, the reactive component that reacts with the resin may be an isocyanate containing compound, and the resulting polymeric composite material is a polyurethane. Alternatively, if an epoxy resin is used, the reactive component that reacts with the resin may be a hardener, such as a polyamine or polyamide, and the resulting polymeric composite material is an epoxy.

The components may be present in the repair kit 100 in amounts that allow a complete reaction between the resin component and the reactive component. Thus, the ratio of the resin component to the reactive component may be determined based on the specific components present in the repair kit. Moreover, the amount of catalyst present in the repair kit may also be dependent on the amount and choice for reactive component and resin component. The filler amount may be affected by various factors including type of filler and intended service use.

Different resins can be used to form different types of polymeric composite materials. The resin component may be an epoxy resin, a polyol resin, a polyurea resin, or a combination thereof. A polyol resin may include a polyol with a hydroxyl-terminated backbone of a member selected from the group consisting of polyether, polyester, polycarbon, polydiene, and polycaprolactone. A polyol resin component may comprise a single polyol or a mixture of polyols. For example, the polyol resin component may contain one polyol, two polyols, three polyols, or four or more polyols. In embodiments, the resin component may comprise a mixture of two or three polyols.

The polyol resin may include a polyol selected from the group consisting of a hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. The polyol resin may also include adipic acid-ethylene glycol polyester, polybutylene glycol, polypropylene glycol or hydroxyl-terminated polybutadiene. In an exemplary embodiment, the resin is preferably polypropylene glycol. The aforementioned list of polyols is representative of the resins that may be used. However, the polyol suitable for use is not particularly restricted. U.S. Pat. No. 6,635,737, hereby incorporated by reference in its entirety, provides additional polyols that may be used.

The resin may be stored separately in the repair kit in its own compartment or it may be combined with one or more other components in a compartment for storage prior to use of the repair kit. For example, it may be stored in combination with the catalyst.

The reactive component in a repair kit may be dependent on the type of resin present in the repair kit. For example, an isocyanate containing compound can be reacted with a polyol resin to form a polyurethane composite material. The isocyanate containing compound should have at least one isocyanate functional group. The functional group may be an aliphatic isocyanate, a cycloaliphatic isocyanate, an aryl isocyanate, an aromatic cyanate, or a combination thereof. The functional group may be 1,6-hexamethylene diisocyanate, 1,4-butylene diisocyanate, furfurylidene diisocyanate, 2,4-toluene diisocyanate, 2,6-toluene diisocyanate, 2,4′-diphenylethane, diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenze, 2,4-diisocyanate-s-triazine, 1-methyl-2,4-diisocyanato cyclohexane, p-phenylene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates or a combination thereof. In an exemplary embodiment, the preferred isocyanate functional group may be polymethylene polyphenyl polyisocyanates. The aforementioned list of isocyanate functional groups is representative of the isocyanate functional groups that may be used. However, the isocyanate functional groups suitable for use are not particularly restricted. U.S. Pat. No. 5,422,385, hereby incorporated by reference in its entirety, provides additional isocyanates that may be used.

The repair kit 100 may include a catalyst to accelerate the reaction between the resin and the reactive component. The catalyst may include amine compounds and metal-based compounds. Exemplary metal compounds may be based on tin, mercury, lead, bismuth, and zinc. Exemplary amine compounds may include tertiary amines such as triethylenediamine (TEDA), dimethylcyclohexylamine (DMCHA), and dimethylethanolamine (DMEA). The catalyst may be stored separately in the repair kit in its own compartment or it may be combined with one or more other components in a compartment for storage prior to use of the repair kit. For example, it may be stored in combination with the resin or with the filler.

A filler may also be included as a component in the repair kit. Exemplary fillers include glass, sand, rock, rubber crumb, architectural stone, low density fillers such as polystyrene beads (expanded or unexpanded) or expanded glass beads, or combinations thereof. In exemplary embodiments, the filler may be glass beads, for example, recycled glass beads. Other types of glass may also be suitable for use as a filler. The glass may be of any type and may be clear, tinted, and/or colored. For example, the glass may be post-consumer waste recycled glass such that economic and environmental costs are minimized.

In some embodiments, the polymeric composition comprises a resin component, a reactive component, and an aggregate component. The polymeric composition is a chemically curing composition, such that when the resin component and the reactive component are mixed, the components chemically react to form a polymeric composition that becomes solid over time and can be used to repair damaged surfaces and other areas in need of repair. Generally speaking, the resin component and the reactive component may be in the form of a liquid, solid, or a combination thereof. In preferred embodiments, the resin component and the reactive component are in the form of a liquid. In preparing the polymeric composition, no blowing agent or mechanism for producing gas which would lead to cell development is present. Thus, the polymeric composition is non-cellular. In use, the aggregate component is initially combined with one of the resin component or the reactive component to form a filled resin component or a filled reactive component and then the filled component is mixed with the non-filled component to form the polymeric composition.

In an exemplary embodiment, the aggregate component is mixed with the resin component to form a filled resin component. Then the filled resin component is mixed with the reactive component. The filled resin component can be mixed in varying volumes with the reactive component. Thus, a volume ratio of the volume of filled resin component to the volume of reactive component can vary with application, and may depend on a number of considerations, including, but not limited to, component properties, location of repair area, type of repair being performed, etc. The volume ratio may be from 9:1 filled resin component to reactive component to 1:9 filled resin component to reactive component. Exemplary embodiments may include volume ratios of 4:1, 3:2, and 2:1 filled resin component to reactive component.

Exemplary aggregate materials may include glass, sand, rock, rubber crumb, architectural stone, polystyrene, expanded glass, or combinations thereof. In exemplary embodiments, the aggregate may comprise polystyrene beads. Further, more than one type of material can be used as the aggregate component. The material(s) used for the aggregate component can be chosen based on the performance characteristics and properties that are desired for the final polymeric composition.

The aggregate component has physical properties that enable the filled component and the polymeric composition to flow, be pumped, mixed, and dispensed or applied to an area in need of repair as a homogenous mixture or slurry. The aggregate component is generally spherical in shape. As used herein, the terms “spherical”, “sphere”, and “round” can be used interchangeably and mean generally shaped like a sphere or generally rounded. The terms do not require a perfectly round geometrical shape but rather encompass a shape that is generally rounded or spherical, without sharp points or edges. The spherical shape aids in flowability and pumpability of the polymeric composition.

The size of the aggregate component can have an effect on flowability and ease of use of the polymeric composite. For example, if the aggregate is too large, the polymeric composition may not mix and homogenize as well as it would if the aggregate were smaller. Additionally, a larger diameter aggregate may have difficulty flowing freely through various dispensing devices, for example, pumping, metering, and mixing devices. If the aggregate is too small, the polymeric composition may experience a thickening effect during preparation and application to an area in need of repair. For example, flowability difficulties due to thickening may be evident during pumping, metering, mixing, and/or dispensing. The aggregate component generally has an average diameter of about 0.1 mm to about 10 mm. In an exemplary embodiment, the aggregate component may have an average diameter of about 0.3 mm to about 3 mm. In a further exemplary embodiment, the aggregate component may have an average diameter of about 0.4 mm to about 1 mm. The aggregate component may also be described as having an average diameter no larger than about 10 mm, 9 mm, 8 mm, 7 mm, 6 mm, 5 mm, 4 mm, 3 mm, 2 mm, or 1 mm and no smaller than about 0.1 mm. The aggregate component may also be described as having an average diameter no larger than about 10 mm and no smaller than about 3 mm, 2 mm, 1 mm, 0.9 mm, 0.8 mm, 0.7 mm, 0.6 mm, 0.5 mm, 0.4 mm, 0.3 mm, 0.2 mm, or 0.1 mm.

It may be difficult to ensure that every individual aggregate particle within the aggregate component has a single diameter value. Thus, the diameter of the aggregate component can be provided in a value range. For example, the aggregate component may have a diameter range of from about 0.5 mm to about 1 mm, from about 1 mm to about 1.5 mm, or from about 0.75 mm to about 1.5 mm.

The combined aggregate and resin or reactive component can be pumped using standard equipment and hoses and dispensed through a proportioning device and mixing device easily and continuously without having flowability and transfer problems.

For the polymeric composition described herein, the selected aggregate and one of the liquid resin or reactive components have a similar density. The similarity in density allows for the mixture of aggregate and resin or reactive components to be homogeneous such that the aggregate does not settle or float relative to the liquid resin or reactive component. The similar ‘in-situ’ density of the aggregate is based on the intrinsic properties of the selected aggregate and the design of either the liquid resin or reactive component. For example, the aggregate may be polystyrene beads with an in-situ density of 9.0 to 9.2 lbs/gallon, and the resin component may have a density of 9.1 to 9.2 lbs/gallon.

The ‘in-situ’ density refers to the weight per volume ratio of the aggregate, excluding the void space between each individual particle that would otherwise be included in the measured bulk density of the aggregate. The ‘in-situ’ density of the aggregate can be measured using a volume displacement method for a known mass of aggregate placed into the liquid resin or reactive component. The density of the liquid resin or reactive component can be easily measured by any density method typically used for liquids. For example, a method using a calibrated stainless steel weight per gallon cup from the Paul N. Gardner Company could be used. The aggregate component should have an ‘in-situ’ density that is similar to the density of the component in which it is initially placed (the resin component or the reactive component). For example, when making the polymeric composition, if the aggregate component is mixed with the resin component first, the in-situ density of the aggregate component should be similar to the density of the resin component. Alternatively, if the aggregate component is mixed with the reactive component first, then the density of the aggregate component should be similar to the density of the reactive component. In embodiments, the densities of the resin component, reactive component, and aggregate component may all be similar to one another.

The term “similar density” as used herein means that the aggregate component has an in-situ density within at least about 2 lbs per gallon, more preferably within at least about 1 pound per gallon of the density of the material with which it has a similar density (the “reference material”). One of the resin component or the reactive component will be the reference material. Further, the reference material is the component with which the aggregate component is mixed first, prior to being mixed with the non-reference material.

The term similar density encompasses a density within about 2 lbs/gallon of the density of the reference material to a density that is negligibly different from the density of the reference material. For example, a similar density may be within 1.5 lbs/gallon, 1.0 lbs/gallon, 0.9 lbs/gallon, 0.8 lbs/gallon, 0.7 lbs/gallon, 0.6 lbs/gallon, 0.5 lbs/gallon, 0.4 lbs/gallon, 0.3 lbs/gallon, 0.2 lbs/gallon, and 0.1 lbs/gallon of the density of the reference material. It will be understood that a similar density can include a density that is greater than or less than the density of the reference material, as long as it is within 2 lbs/gallon of the density of the reference material. Further, the term “similar density” may also include a density that is within 10% of the density of the reference material. For example, the density may be within 9%, 8%, 7%, 6%, 5%, 4%, 3%, 2%, or 1% of the density of the reference material.

The aggregate component may have an in-situ density in a range of about 7 lbs/gallon to about 25 lbs/gallon, for example in a range of about 9 lbs/gallon to about 12 lbs/gallon. In examples, the aggregate may have a density of at least about 7 lbs/gallon, at least about 8 lbs/gallon, at least about 9 lbs/gallon, at least about 10 lbs/gallon, at least about 11 lbs/gallon, at least about 12 lbs/gallon, at least about 13 lbs/gallon, at least about 14 lbs/gallon, at least about 15 lbs/gallon, or at least about 20 lbs/gallon. In other examples, the aggregate may have a density in a range of at most about 20 lbs/gallon, at most about 15 lbs/gallon, at most about 14 lbs/gallon, at most about 13 lbs/gallon, at most about 12 lbs/gallon, at most about 11 lbs/gallon, at most 10 lbs/gallon, at most about 9 lbs/gallon, at most about 8 lbs/gallon, or at most about 7 lbs/gallon. Low density fillers may also be used. A low density filler may have a density in the range of about 15 to 55 lb/ft³.

The term “in-situ” refers to the density of the aggregate in the reference material. The term “in-situ” is used to differentiate the bulk density of the aggregate from the density of the aggregate in a liquid material. Herein, the liquid material is the reference material. The “in-situ” density excludes the void space that is present when dry aggregate particles are collectively measured. For example, the bulk density of a volume of dry beads can be measured in a container. The bulk density of the dry beads will be less than the density of the beads measured when the beads are mixed with a liquid because the void space filled with air that surrounds each individual bead particle is not present when the density is measured in a liquid. The “in-situ” density does not include the air space around the individual particles of aggregate.

The aggregate component can be combined with the reference material (one of the resin component or the reactive component) in varying amounts. For example, the aggregate component may comprise up to 70 volume % of the mixture of the aggregate component and the reference material (the “filled mixture”). For example, the volume % of aggregate material may be up to 70%, 60%, 50%, 40%, 30%, 20%, 10%, 5%, and 1%. The volume percent of aggregate in the filled mixture may be between about 25-55 volume %. The volume or loading percent of aggregate component may depend on the requirements of the application and/or the characteristics of the aggregate component itself. The volume or loading percent of the aggregate component can affect performance characteristics of the filled mixture and the polymeric composition. If the loading of aggregate is too high, the filled mixture and/or polymeric composition may not have the flow characteristics that enable pumping with standard, commercially available equipment. For example, the polymeric composition may be too thick to flow readily. It is desirable to load the aggregate component as high as possible to minimize cost (assuming the aggregate component is less expensive than the surrounding material) while maintaining flowability. Additionally, the percentage of the composition that is comprised of aggregate component can be adjusted based on the desired characteristics of the filled mixture and also the final polymeric composition.

Further information regarding suitable resin components, reactive components, aggregate components, catalysts, fillers may be found in U.S. Ser. No. 14/854,668, filed Sep. 15, 2015, and U.S. Ser. No. 16/328,316, filed Feb. 26, 2019, hereby incorporated by reference in their entirety.

FIG. 3 shows a shows an embodiment of dispensing cap 20 of a repair kit 100. The dispensing cap 20 includes a dispensing body 22, a nozzle 24, and an opening 26. In this embodiment, the dispensing body 22 of the dispensing cap 20 has a generally circular configuration and is configured to fit an end of the housing 10. It should be understood that the configuration of the dispensing cap may be designed based on the configuration of the housing 10. The dispensing cap 20, when positioned on an end of the housing 10, helps to retain the sealed container within the interior surface of the housing 10 when the kit is assembled. As discussed above, the dispensing cap 20 may include an attachment mechanism 28 positioned on the dispensing body 22. As shown, the attachment mechanism 28 is designed for a push fit about an outer edge of the housing 10. In alternative embodiments, the attachment mechanism 28 may comprise threads, clips, press fit, snap-fit arrangement, or other suitable known mechanism. The nozzle 24 of the dispensing cap 20 extends from the surface of the dispensing body 22 and has a first perimeter 25 and a second perimeter 27, both of which including an outer diameter. The nozzle 24 includes an attachment mechanism, such as threading, in order to allow the attachment of other accessories, such as a dispensing tip. The opening 26 is disposed through the nozzle 24 of the dispensing cap 20 and extends through the body 22 of the dispensing cap 20. The opening 26 may range from 19 mm to 31.8 mm in diameter. This diameter allows for the dispensing end of the sealed container 40 to be received and pulled through the opening 26 when the repair kit 100 is fully assembled.

Suitable materials for use in constructing dispensing cap 20 include (but are not limited to) plastic, wood, metal, rubber, and the like. The dispensing cap 20 can be constructed using any method known and used in the art, including (but not limited to) injection molding, casting, insert molding, machining, additive or subtractive manufacturing techniques, and the like.

FIG. 4 shows an embodiment of pusher 30 of a repair kit 100. As shown, the pusher 30 has a generally circular configuration having a first surface 32 and a plurality of gaps 34 formed between ribs 36 and rings 38. The plurality of gaps 32 are provided to allow for airflow when the pusher is in use. The pusher 30 is designed to fit snugly within the interior surface of the housing 15 and allow for an actuator of a dispensing device, such as a caulking gun, to successfully and even fully depress the sealed container 40 and dispense the contents of the sealed container 40 when the repair kit 100 is in use. Accordingly, the diameter of the pusher 30 is selected such that it is approximate to the inner diameter of the housing 10. The sizing of the diameter of the pusher is important in order to allow for sufficient contact between the pusher 30 and the sealed container 40 when the kit is in use. The first surface 32 of the pusher 30 also includes a substantially flattened surface, which is engagable with the actuator of a dispensing apparatus. The pusher may also include an element, such as a roughened surface, that allows for the pusher 30 to be removed from the housing 10 of the repair kit 100.

Suitable materials for use in constructing the pusher 30 include (but are not limited to) plastic, wood, metal, rubber, and the like. The pusher 30 can be constructed using any method known and used in the art, including (but not limited to) injection molding, casting, insert molding, machining, additive or subtractive manufacturing techniques, and the like.

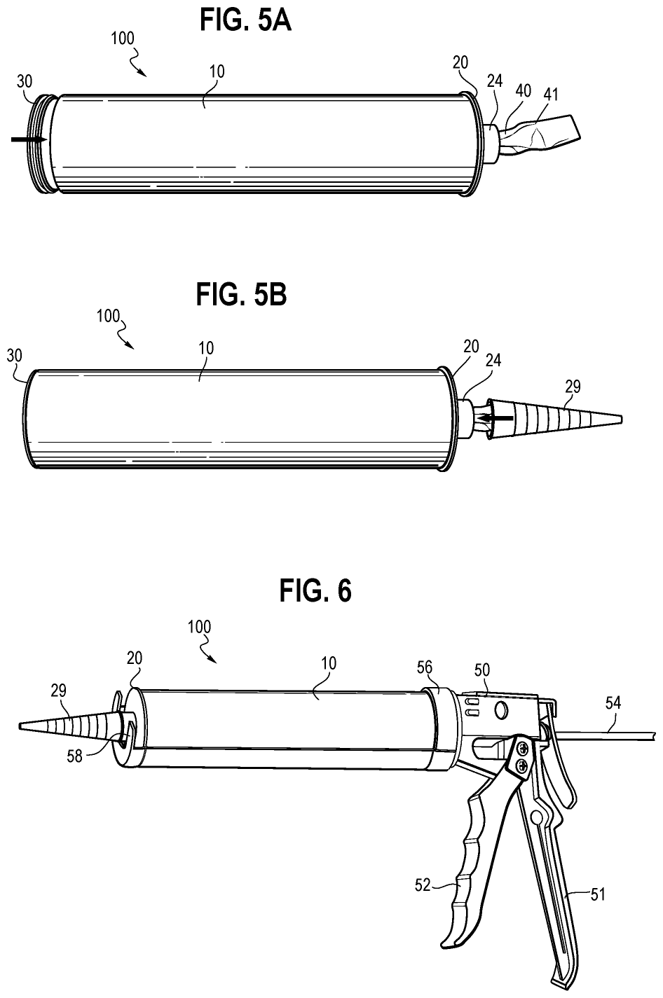

FIGS. 5A and 5B show an embodiment of the repair kit 100 partially assembled. As shown, the repair kit 100 includes comprising a housing 10, dispensing cap 20, a pusher 30, and a sealed container 40. In FIG. 5A, the dispensing cap 20 is positioned on one end of the housing 10 and the pusher 30 is positioned on the opposite end of the housing 10. As discussed above, the dispensing cap 20 includes an attachment mechanism 28 that engages with the end of the housing 10. The sealed container 40 in this embodiment is positioned within an interior surface of the housing 10, where a dispensing end 41 of the sealed container 40 is disposed through the nozzle 24 of the dispensing cap 20. Prior to placing the sealed container 40 within the interior surface of the housing, the divider 42 is removed from sealed container 40 and the contents of the sealed container can be combined and mixed by hand within the sealed container 40. Once the dispensing end 41 of the sealed container is positioned within the nozzle 24 of the dispensing cap 20, a user may cut the dispensing end 41 in order to facilitate dispensing the product. Following the removal of a portion of the dispensing end 41, a dispensing tip 29 may be attached to the nozzle 24 of the dispensing cap 30.

Referring now to FIG. 6, show an embodiment of the repair kit 100 fully assembled and positioning within a dispensing apparatus 50. As shown, the repair kit 100 includes comprising a housing 10, dispensing cap 20, a pusher 30, and a sealed container 40. The dispensing cap 20 is positioned on one end of the housing 10 and the pusher 30 is positioned on the opposite end of the housing 10. As discussed above, the dispensing cap 20 includes an attachment mechanism that engages with the end of the housing 10. The sealed container 40 in this embodiment is positioned within an interior surface of the housing 10, where a dispensing end 41 of the sealed container 40 is disposed through the nozzle 24 of the dispensing cap 20. A dispensing tip 29 is attached to the nozzle 24 of the dispensing cap 30. The dispensing apparatus 50, such as a dispensing gun, includes a handle 51, a trigger 52; an actuator 54 to engage with the pusher 30 and move the pusher 30 through the housing 10 and thus push the sealed container 40 toward the first end 12 of the housing; a barrel 56 to hold the housing 10 of the repair kit 100; and a wall 58 against which the dispensing cap 30 can abut. In other embodiments, the dispenser apparatus 50 may have other configurations known in the art.

A repair kit 100 of the present invention may be used at the interface of two substrates in order to provide permanent adhesion to a surface at or adjacent to a dwelling. In one aspect, the repair kit 100 may be used to secure a fixture to a wall or other surface. In particular, the divider 42 is removed from the sealed container 42. The sealed container comprising a first compartment comprising a resin component and a second compartment comprising a reactive component. After the removable divider 42 is disengaged, the components previously separated by the divider may be combined and mixed within the sealed container 40. Once the components within the sealed container are mixed and combined, at least a portion of an end of the sealed container is detached to form a dispensing end 41. Once the dispensing end of the sealed container 40 is formed, the sealed container 40 is positioned within the interior surface of the housing 10. The dispensing end 41 is positioned such that it is aligned with the second opening of the second end of the housing. Once the sealed container 40 is positioned within the interior surface of the housing 10, a pusher 30 is positioned within the interior surface of the housing 10 through the first opening 16 of the first end 12 of the housing 10. The second end 14 of the housing 10 is releasably sealed with a dispensing cap 20. The dispensing end 41 of the sealed container 40 may be positioned within the opening 26 of the dispensing cap 20. The housing 10 is then positioned within the barrel 56 of a dispensing apparatus 50 such that an actuator 54 of the dispensing gun 50 is in contact with the pusher 30 and the dispensing cap 20 abuts against a wall 58 of the dispensing gun. Once the housing 10 is positioned within the dispensing apparatus 50, the composite material may be dispensed upon the object by compressing the trigger 52 of the dispensing apparatus 50, which causes engagement of the actuator 54 and the pusher 30 and securing the object at or adjacent to a dwelling.

A kit of the present invention may also be used in repair as a filler or sealant. In one aspect, the repair kit may be used to repair a fissure or opening. In particular, the divider 42 is removed from the sealed container 42. The sealed container comprising a first compartment comprising a resin component and a second compartment comprising a reactive component. After the removable divider 42 is disengaged, the components previously separated by the divider may be combined and mixed within the sealed container 40. Once the components within the sealed container are mixed and combined, at least a portion of an end of the sealed container is detached to form a dispensing end 41. Once the dispensing end of the sealed container 40 is formed, the sealed container 40 is positioned within the interior surface of the housing 10. The dispensing end 41 is positioned such that it is aligned with the second opening of the second end of the housing. Once the sealed container 40 is positioned within the interior surface of the housing 10, a pusher 30 is positioned within the interior surface of the housing 10 through the first opening 16 of the first end 12 of the housing 10. The second end 14 of the housing 10 is releasably sealed with a dispensing cap, the dispensing cap 20. The dispensing end 41 of the sealed container 40 may be positioned within the opening 26 of the dispensing cap 20. The housing 10 is then positioned within the barrel 56 of a dispensing apparatus 50 such that an actuator 54 of the dispensing gun 50 is in contact with the pusher 30 and the dispensing cap 20 abuts against a wall 58 of the dispensing gun. Once the housing is positioned within the dispensing apparatus 50, the composite material may be dispensed into the fissure of a household surface by compressing the trigger 52 of the dispensing apparatus 50, which causes engagement of the actuator 54 and the pusher 30.

A kit of the present invention may further be used to apply a coating. In one aspect, the repair kit may be used to apply a coating to a surface. In particular, the divider 42 is removed from the sealed container 42. The sealed container comprising a first compartment comprising a resin component and a second compartment comprising a reactive component. After the removable divider 42 is disengaged, the components previously separated by the divider may be combined and mixed within the sealed container 40. Once the components within the sealed container are mixed and combined, at least a portion of an end of the sealed container is detached to form a dispensing end 41. Once the dispensing end of the sealed container 40 is formed, the sealed container 40 is positioned within the interior surface of the housing 10. The dispensing end 41 is positioned such that it is aligned with the second opening of the second end of the housing. Once the sealed container 40 is positioned within the interior surface of the housing 10, a pusher 30 is positioned within the interior surface of the housing 10 through the first opening 16 of the first end 12 of the housing 10. The second end 14 of the housing 10 is releasably sealed with a dispensing cap, the dispensing cap 20. The dispensing end 41 of the sealed container 40 may be positioned within the opening 26 of the dispensing cap 20. The housing 10 is then positioned within the barrel 56 of a dispensing apparatus 50 such that an actuator 54 of the dispensing gun 50 is in contact with the pusher 30 and the dispensing cap 20 abuts against a wall 58 of the dispensing gun. Once the housing is positioned within the dispensing apparatus 50, the composite material may be dispensed onto a household surface or object by compressing the trigger 52 of the dispensing apparatus 50, which causes engagement of the actuator 54 and the pusher 30.

An embodiment of the invention may include a method for applying a coating, comprising: removing a divider from a sealed container, the sealed container comprising a first compartment comprising a resin component and a second compartment comprising a reactive component, the divider isolating the first compartment from the second compartment; mixing the resin component and the reactive component in the sealed container to form a composite material; detaching at least a portion of an end of the sealed container to form a dispensing end; placing the sealed container into a housing, the housing having a generally tubular configuration defining an interior space, a first end with a first opening and a second end with a second opening, aligning the dispensing end of the sealed container with the second opening of the second end; positioning a pusher within the interior space of the housing through the first end of the housing with a pusher; releasably sealing the second end of the housing with a dispensing cap, the dispensing cap having an opening; placing the housing into a body of a dispensing apparatus; dispensing the composite material onto a household object or surface.

Many modifications and other embodiments of the present disclosure will come to mind to one skilled in the art to which the present disclosure pertains having the benefit of the teachings presented in the foregoing description; and it will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A kit, comprising
a housing having a generally tubular configuration defining an interior space, a first end with a first opening and a second end with a second opening;
a sealed container adapted to be positioned within the interior space of the housing;
a divider positioned along a transverse axis of the sealed container and forming a first compartment and a second compartment, the first compartment and the second compartment isolated from one another by the divider;
a pusher releaseably engageble with the interior space of the housing,
a dispensing cap releaseably engagable with the second end of the housing; and
wherein the first compartment includes a resin component having a resin density, and
wherein the second compartment includes a reactive component having a reactive component density.

2. The kit of claim 1, wherein the sealed container further comprises an aggregate component having a spherical shape, a diameter of about 0.1 mm to about 10 mm an aggregate density, wherein the density of the aggregate component is within 2 lbs./gallon of the density of at least one of the resin component or the reactive component wherein the density of the aggregate component is within 1 lbs./gallon of the density of the at least one of the resin component or the reactive component.

3. The kit of claim 2, wherein the density of the aggregate component is within 0.5 lbs/gallon of the density of the at least one of the resin component or the reactive component.

4. The kit of claim 2, wherein the density of the aggregate component is within 5% of the density of the at least one of the resin component or the reactive component.

5. The kit of claim 1, wherein the housing is about 215 mm in length and about 50 mm in outer diameter.

6. The kit of claim 1, wherein the resin component comprises an epoxy resin, a polyol resin, a polyurethane forming resin, or a polyurea resin.

7. The kit of claim 1, wherein the reactive component comprises an isocyanate containing compound or an epoxy hardener.

8. The kit of claim 1, wherein the dispensing cap is a threaded cap.

9. The kit of claim 1, wherein the sealed container includes a perforated detach line positioned near an end of the sealed container.

10. The kit of claim 9, wherein the perforated detach line is positioned along a transverse axis of the sealed container.

11. The kit of claim 9, wherein the perforated detach line is position at an angle less than 90 degrees with respect to a transverse axis of the sealed container.

12. A method for securing an object, comprising:
removing a divider from a sealed container, the sealed container comprising a first compartment comprising a resin component and a second compartment comprising a reactive component, the divider isolating the first compartment from the second compartment;
mixing the resin component and the reactive component in the sealed container to form a composite material;
detaching at least a portion of an end of the sealed container to form a dispensing end;
placing the sealed container into a housing, the housing having a generally tubular configuration defining an interior space, a first end with a first opening and a second end with a second opening,
aligning the dispensing end of the sealed container with the second opening of the second end;
positioning a pusher within the interior space of the housing through the first end of the housing with a pusher;
releasably sealing the second end of the housing with a dispensing cap, the dispensing cap having an opening;
placing the housing into a body of a dispensing apparatus,
dispensing the composite material upon the object by engaging the plunger; and
securing the object to a surface at or adjacent to a dwelling.

13. The method of claim 12, wherein the dispensing cap includes a releasable dispensing nozzle.

14. The method of claim 12, wherein the sealed container includes a perforated detach line positioned near an end of the sealed container to facilitate the detaching step.

15. The method of claim 14, wherein the perforated detach line is positioned along a transverse axis of the sealed container.

16. The method of claim 14, wherein the perforated detach line is positioned at an angle less than 90 degrees with respect to a transverse axis of the sealed container.

17. The method of claim 12, wherein the dispensing apparatus includes an actuator connected to a portion of the body, the actuator adapted to engage with the plunger.

18. The method of claim 12, wherein the housing is about 215 mm in length and about 50 mm in outer diameter.

19. The method of claim 12, wherein the resin component comprises an epoxy resin, a polyol resin, a polyurethane forming resin, or a polyurea resin.

20. A method for repairing a fissure, comprising:
removing a divider from a sealed container, the sealed container comprising a first compartment comprising a resin component and a second compartment comprising a reactive component, the divider isolating the first compartment from the second compartment;
mixing the resin component and the reactive component in the sealed container to form a composite material;
detaching at least a portion of an end of the sealed container to form a dispensing end;
placing the sealed container into a housing, the housing having a generally tubular configuration defining an interior space, a first end with a first opening and a second end with a second opening,
aligning the dispensing end of the sealed container with the second opening of the second end;
positioning a pusher within the interior space of the housing through the first end of the housing with a pusher;
releasably sealing the second end of the housing with a dispensing cap, the dispensing cap having an opening;
placing the housing into a body of a dispensing apparatus;
dispensing the composite material into a fissure of a household surface by engaging the pusher.
